(19) United States
(12) Patent Application Publication
(10) Pub. No.: US 2026/0301637 A1
(43) Pub. Date: Oct. 1, 2026

(54) DISPLAY APPARATUS AND DISPLAY METHOD THEREOF

(71) Applicant: SAMSUNG ELECTRONICS CO., LTD., Suwon-si (KR)

(72) Inventor: Kihyung KANG, Suwon-si (KR)

(73) Assignee: SAMSUNG ELECTRONICS CO., LTD., Suwon-si (KR)

(21) Appl. No.: 19/636,289

(22) Filed: Apr. 1, 2026

Related U.S. Application Data
(63) Continuation of application No. PCT/KR2026/002546, filed on Feb. 11, 2026.

(30) Foreign Application Priority Data
Apr. 1, 2025 (KR) 10-2025-0042187

(51) Int. Cl. G09G 3/20; G09G 3/00; G09G 3/34

(52) U.S. Cl. CPC G09G 3/2044; G09G 3/001; G09G 3/2092; G09G 3/344; G09G 2320/0242

(57) ABSTRACT

Provided is a display apparatus including a display including a plurality of pixels included in a pixel column unit, the plurality of pixels being configured to be driven based on electrophoretic process, a three-dimensional film including a plurality of refractive regions and on a plurality of pixel columns of the display, memory configured to store instructions, and one or more processors including processing circuitry, when executing the instructions, is configured to cause the display apparatus to perform dithering in units of a plurality of pixels consecutively included in each pixel column of the plurality of pixel columns to adjust grayscale for each view of a plurality of views.

### CROSS-REFERENCE TO RELATED APPLICATIONS

This application is a bypass continuation of International Application No. PCT/KR2026/002546, filed on Feb. 11, 2026, which is based on and claims priority to Korean Patent Application No. 10-2025-0042187, filed on Apr. 1, 2025, in the Korean Intellectual Property Office, the disclosures of which are incorporated by reference herein in their entireties.

### BACKGROUND

### 1. Field

Apparatuses and methods consistent with the present disclosure relate to a display apparatus and a display method thereof, and more particularly, with a display apparatus that operates by an electrophoretic method, and a display method thereof.

### 2. Description of Related Art

According to the development of electronic technology, various types of display apparatuses are being developed. An example of display apparatuses includes a display apparatus that is driven by an electrophoretic method. Such a device may be referred to as electronic paper (E paper).

Such a display apparatus has a problem in that it is difficult to express grayscale and color due to the limitation of its driving method.

### SUMMARY

According to an aspect of one or more embodiments, there is provided a display apparatus including a display including a plurality of pixels included in a pixel column unit, the plurality of pixels being configured to be driven based on electrophoretic method, a three-dimensional film including a plurality of refractive regions and on a plurality of pixel columns of the display, memory configured to store instructions, and one or more processors including processing circuitry, when executing the instructions, is configured to cause the display apparatus to perform dithering in units of a plurality of pixels consecutively included in each pixel column of the plurality of pixel columns to adjust grayscale for each view of a plurality of views.

Each pixel column of the plurality of pixel columns may include the plurality of pixels in a vertical direction, and each refractive region of the plurality of refractive regions may extend in the vertical direction.

The one or more processors, when executing the instructions, may be further configured to cause the display apparatus to display different content in unit of at least one pixel column of the plurality of pixel columns within each refractive region of the plurality of refractive regions.

The one or more processors, when executing the instructions, may be further configured to cause the display apparatus to perform the dithering in units of pixels, of which number is same as a number of the plurality of pixel columns, among pixels included in each pixel column of the plurality of pixel columns included in each refractive region of the plurality of refractive regions.

Each pixel column of the plurality of pixel columns may include the plurality of pixels in a vertical direction, and each refractive region of the plurality of refractive regions may extend in a direction inclined at a preset angle with respect to the vertical direction.

Each refractive region of the plurality of refractive regions may be divided into a plurality of regions having different refractive indices, and wherein the one or more processors, when executing the instructions, may be further configured to cause the display apparatus to display different content in units of pixels corresponding to each region of the plurality of regions within each refractive region of the plurality of refractive regions.

The one or more processors, when executing the instructions, may be further configured to cause the display apparatus to perform the dithering in units of pixels, of which number is same as a number of pixel columns included in each refractive region of the plurality of refractive regions, among pixels corresponding to each region of the plurality of regions.

The three-dimensional film may be a lenticular lens, and the plurality of refractive regions may be a plurality of lens regions in the lenticular lens.

According to an aspect of one or more embodiments, there is provided a display method of a display apparatus including a display in which a plurality of pixels, each configured to be driven by an electrophoretic method, are in a pixel column unit, and a three-dimensional film divided into a plurality of refractive regions and on a plurality of pixel columns of the display, the display method including displaying different content for each view of a plurality of vies by using pixels in the plurality of pixel columns within each refractive region of the plurality of refractive regions, and adjusting grayscale for each view of a plurality of view by performing dithering in units of a plurality of pixels consecutively in each pixel column of the plurality of pixel columns within each refractive region of the plurality of refractive regions.

Each pixel column of the plurality of pixel columns may include the plurality of pixels in a vertical direction, and each refractive region of the plurality of refractive regions may extend in the vertical direction.

The displaying of the different content for each view of the plurality of view may include displaying different content in unit of at least one pixel column among the plurality of pixel columns within each refractive region of the plurality of refractive regions.

The adjusting of the grayscale for each view may include performing the dithering in units of pixels, of which number is same as a number of the plurality of pixel columns, among pixels included in each pixel column of the plurality of pixel columns included in each refractive region of the plurality of refractive regions.

Each pixel column of the plurality of pixel columns may include the plurality of pixels in a vertical direction, and each refractive region of the plurality of refractive regions may extend in a direction inclined by a preset angle with respect to the vertical direction.

Each refractive region of the plurality of refractive regions may be divided into a plurality of regions having different refractive indices, and the displaying of the different content for each view of a plurality of views may include displaying different content in units of pixels corresponding to each region of the plurality of regions within each refractive region of the plurality of refractive regions.

The adjusting of the grayscale for each view the plurality of views may include performing the dithering in units of pixels, of which number is same as a number of pixel columns included in each refractive region of the plurality of refractive regions, among pixels corresponding to each region of the plurality of regions.

### BRIEF DESCRIPTION OF DRAWINGS

The above and other aspects and features of the present disclosure will become more apparent by describing in detail exemplary embodiments thereof with reference to the attached drawings, in which:

FIG. 1 is a diagram illustrating an operation of a display apparatus according to one or more embodiments;

FIG. 2 is a block diagram illustrating a configuration of a display apparatus according to one or more embodiments;

FIG. 3 is a diagram illustrating an example of a 3D film attached to a display apparatus according to one or more embodiments;

FIG. 4 is a diagram illustrating a display method of the display apparatus of FIG. 3;

FIGS. 5, 6, and 7 are diagrams for explaining examples of images viewed from different views with respect to the display apparatus performing an operation of FIG. 4;

FIG. 8 is a diagram for explaining another example of a three-dimensional (3D) film attached to the display apparatus according to one or more embodiments; and

FIG. 9 is a flowchart illustrating a display method of a display apparatus according to one or more embodiments.

### DETAILED DESCRIPTION

The present embodiments may apply various conversions and have various embodiments, and thus specific embodiments will be shown in the drawings and described in detail in the detailed description. However, this is not intended to limit the scope to a specific embodiment and should be understood to include various modifications, equivalents, and/or alternatives of the embodiment of the present disclosure. With respect to the description of the drawings, similar reference numerals may be used for similar components.

In describing the present disclosure, when it is determined that a detailed description of a related known function or configuration may unnecessarily obscure the gist of the present disclosure, a detailed description thereof is omitted.

In addition, the following embodiments may be modified into various different forms, and the scope of the present disclosure is not limited to the following embodiments. Rather, these embodiments are provided to make the present disclosure more faithful and complete and to fully convey the present disclosure to one of ordinary skill in the art.

The terms used in the present disclosure are used only to describe specific embodiments and are not intended to limit the scope. A term of a singular number may include its plural number unless explicitly indicated otherwise in the context.

In the present disclosure, expressions such as “have,” “may have,” “include,” “may include,” etc. may indicate the existence of a corresponding feature (e.g., a numerical value, a function, an operation or a component such as parts), and does not exclude the existence of an additional feature.

In the present disclosure, the expressions such as “A or B,” “at least one of A and/or B,” or “at least one or more of A and/or B” may include all available combinations of items listed together. For example, the expressions such as “A or B,” “at least one of A and B,” or “at least one of A or B” may signify all cases of including (1) at least one A, including (2) at least one B, or including (3) both of at least one A and at least one B.

In the present disclosure, expressions “first,” “second,” etc., used herein may qualify various components regardless of a sequence or importance of the components. These expressions are used only to distinguish one component from another component, and do not limit the corresponding components.

When any component (e.g., a first component) is described as “(operatively or communicatively) coupled with/to” or “connected to another component (e.g., a second component)”, it is to be understood that the component may be directly coupled to the other component or may be coupled to the other component through still another component (e.g., a third component).

On the other hand, when any component (e.g., a first component) is described as “directly connected” or “directly connected” to another component (e.g., a second component), it may be understood that no other component (e.g., a third component) exists between the component and the other component.

As used herein, the expression “configured to” may be interchangeably used with, for example, “suitable for”, “having the capacity to”, “designed to”, “adapted to”, “made to”, or “capable of”, according to a situation. The expression “configured to” may not imply only “specially designed to” in a hardware manner.

Instead, in a certain circumstance, the expression “an apparatus configured to” may indicate the apparatus “capable of” together with another apparatus or components. For example, “a processor configured (or set) to perform A, B, and C” may imply a dedicated processor (e.g., an embedded processor) for performing a corresponding operation or a generic-purpose processor (e.g., central processing unit (CPU) or an application processor) capable of performing corresponding operations by executing one or more software programs stored in memory.

In an embodiment, a “module” or a component with a name ending in “~er/~or” may perform at least one function or operation, may be implemented by hardware or software, or be implemented by a combination of hardware and software. In addition, a plurality of “modules” or a plurality of components with names ending in “~ers/~ors” may be integrated in at least one module to be implemented by at least one processor except for a “module” or a component with a name ending in “~er/or” which needs to be implemented by a specific hardware.

On the other hand, various elements and areas in the drawings are schematically drawn. Therefore, the present disclosure is not limited by the relative sizes or spaces drawn in the accompanying drawings.

Hereinafter, an embodiment of the disclosure will be described in detail with reference to the accompanying drawings so as to be easily embodied by one of ordinary skill in the art.

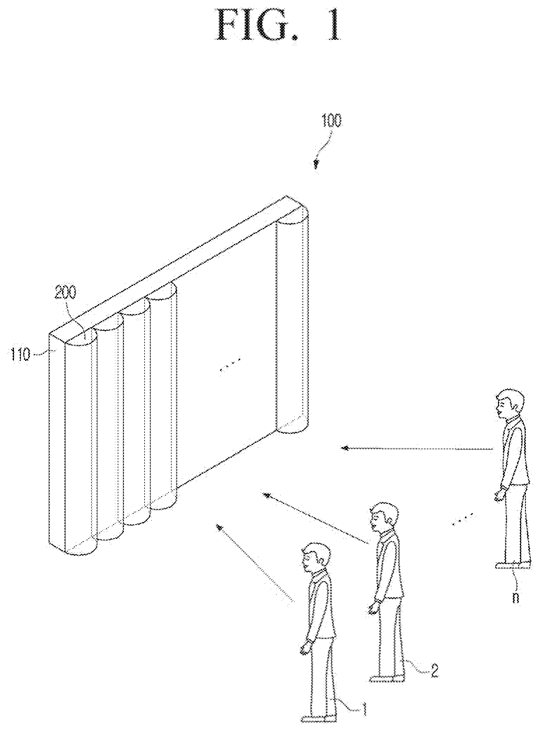

FIG. 1 is a diagram illustrating an operation of a display apparatus 100 according to one or more embodiments.

Referring to FIG. 1, the display apparatus 100 implemented by an electrophoretic method is illustrated.

The display apparatus 100 implemented by the electrophoretic method is a device capable of implementing an image at low power by using an electronic ink, and may be applied to smartphones, tablet PCs, e-book readers, wearable devices such as smart watches, laptops, electronic note pads, electronic shelf labels, digital signage, kiosks, smart cards, medical information display apparatuses, industrial monitoring devices, etc. The display apparatus 100 implemented by the electrophoretic method may be suitably used for various application devices that require a fixed screen to be displayed for a long time or require high readability even under sunlight.

However, the display apparatus 100 implemented by the electrophoretic method is not limited thereto, and may be selectively applied to various types of display apparatuses. The display apparatus 100 implemented by the electrophoretic method may also be otherwise described as an electronic paper device, but in the present disclosure, but is described as the display apparatus 100 in the present disclosure.

In various embodiments of the present disclosure, the display apparatus 100 operating by the electrophoretic method may be implemented as a light field display (LFD) device that implements a stereoscopic image by using an optical element.

LFD is a display technology implemented to enable users to recognize stereoscopic three-dimensional (3D) images without special glasses or additional equipment by more precisely controlling the direction and intensity of light ray in a 3D space.

Specifically, the display apparatus 100 implemented as the LFD may emit light of each of pixels in various directions in a front space by using an optical element, and thus, views change according to users present in various locations, thereby providing a natural parallax, and accordingly providing depth and stereoscopy. The optical element may otherwise be referred to as a 3D film.

Referring to FIG. 1, the display apparatus 100 may include a display 110 and a 3D film 200.

The display 110 may include a plurality of pixels each driven by the electrophoretic method. The plurality of pixels may be arranged in a pixel column unit including a plurality of pixel columns. Each pixel column of the plurality of pixel columns is a pixel group in which a plurality of pixels are arranged side by side in one direction. FIG. 1 illustrates that each pixel column extends in a vertical direction, and the plurality of pixel columns are arranged side by side in a horizontal direction, but a pixel alignment direction and an alignment direction of the pixel columns may be arranged differently in consideration of locations of viewers or content characteristics.

The 3D film 200 may be disposed on a front surface of the display 110 to cover and/or be provided on the display 110. The 3D film 200 is divided into a plurality of refractive regions. Each of the plurality of refractive regions may be arranged in a shape covering a plurality of pixel columns among all pixel columns formed on the lower side of the display 110. That is, n pixel columns may be located in one refractive region.

The plurality of refractive regions may refer to, for example, regions in which a 3D film has a structure with a curvature similar to a convex lens and covers partially or entirely the display 110 when the 3D film is disposed on the front surface of the display 110.

Accordingly, each of the plurality of refractive regions may cover a specific region by refracting light ray emitted from the pixel column covered by each of the plurality of refractive regions so that different image content may be provided according to user's views.

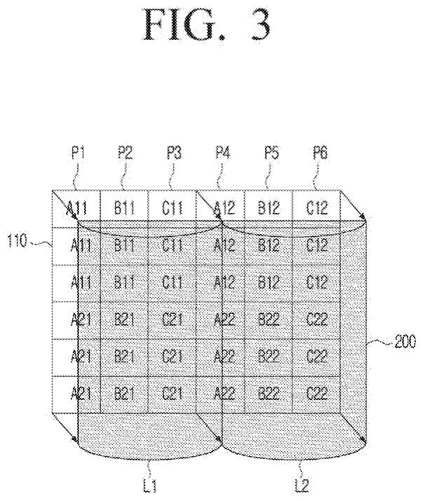

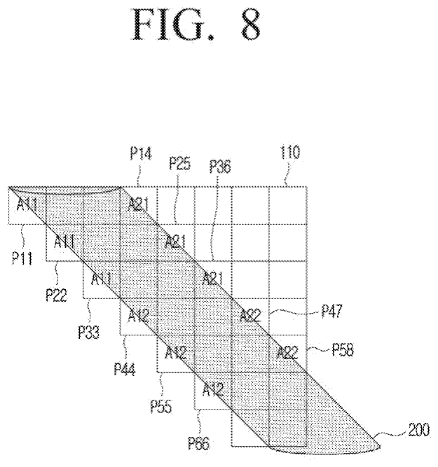

An inclination of the refractive region of the 3D film 200 disposed on the front surface of the display 110 and an inclination of the pixel column may be the same or implemented differently. FIG. 1 illustrates that the pixel columns of the display 110 and lens regions of the 3D film 200 are formed by extending in the same inclination in a vertical direction, but is not necessarily limited thereto, and the lens regions of the 3D film 200 may be arranged in a direction inclined at a preset angle with respect to a direction in which the pixel column extends. This is described with reference to FIGS. 3 and 8.

The 3D film 200 may be implemented in a lenticular lens or a barrier structure. The 3D film 200 may include a plurality of micro lenses or an opening structure to divide, in various directions, or block light ray emitted from the display 110 so that different image information may be recognized according to locations of users. The 3D film 200 may be used to implement a light field, and may be applied in the form of a film instead of a separate lens, thereby reducing the thickness of the display apparatus 100 and simplifying a manufacturing process.

When a plurality of users 1, 2, . . . n are located in front of the display apparatus 100, the users 1, 2, . . . n may recognize different images according to their locations. This may be implemented by an LFD adjusting light ray emitted from a display panel in various directions and providing different light ray information according to views.

That is, the display apparatus 100 may simultaneously output a plurality of images in the same visual space. The display apparatus 100 may enable the plurality of users 1, 2, . . . n to selectively recognize only specific images based on light ray information reaching their views.

Therefore, the users 1, 2, . . . n located in front of the display apparatus 100 may individually appreciate different content (e.g., images, videos, texts, etc.) according to their locations even when looking at the same display screen. Such a structure may be advantageously applied to providing multiview content, displaying personalized information, implementing a multi-user interface, etc. Such an LFD-based structure may provide individualized information without content conflict between users, thereby providing user experiences differentiated from existing two-dimensional (2D) displays.

Accordingly, for example, the first user 1 may recognize content allocated to the first user 1 and may not recognize content allocated to the second user 2.

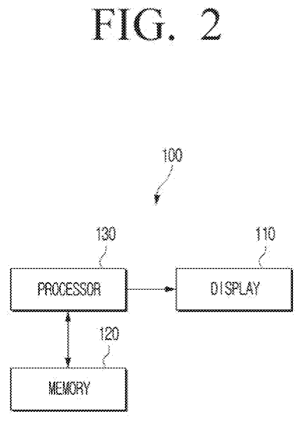

FIG. 2 is a block diagram illustrating a configuration of the display apparatus 100 according to one or more embodiments of the disclosure.

Referring to FIG. 2, the display apparatus 100 may include the display 110, memory 120, and a processor 130.

The display apparatus 100 has been described with reference to FIG. 1, and thus, a redundant description thereof is omitted.

At least one display 11 may refer to a device that receives a specific signal and outputs the signal on a screen in order to provide visual information such as letters, numbers, and images to a user.

The display 110 may arrange a plurality of pixels each driven by an electrophoretic method in a pixel column unit.

The electrophoretic method refers to a driving method for the display 110 to implement an image by applying an electric field and moving charged particles. Such a method controls particles by electrostatic force, enabling low power driving, and has non-volatile characteristics capable of maintaining images for a certain period of time even when the power is cut off. The electrophoretic method is mainly used in e-book terminals, and has the advantage of providing a relatively simple structure and excellent readability.

For example, the display 110 operating by the electrophoretic method includes a substrate, a plurality of lower electrodes formed on the substrate, a plurality of cells respectively disposed on the lower electrodes, and a plurality of upper electrodes disposed according to and/or corresponding to the cells. The upper electrodes may be implemented as transparent electrodes.

The cells may otherwise be referred to as capsules or microcapsules. Particles with different colors and charged polarities are accommodated in each of the cells. For example, black (−charge) particles and white (+charge) particles are included in the case of a black and white display apparatus. In this state, when voltages are applied to the upper electrode and the lower electrode corresponding to some cells, particles corresponding to voltage polarities move upward. For example, when black particles move upward, the corresponding cell becomes black. On the substrate, a wiring electrically connected to each of the upper electrodes and the lower electrodes, a control circuit for controlling the operation of each electrode through the wiring, or a driving IC may be disposed.

The display 110 may include a plurality of pixels for implementing videos or images, and the pixels are arranged in a matrix form on a display panel and control the brightness or color of each of the pixels according to a predetermined signal to constitute the entire screen.

The plurality of pixels may be arranged in a form occupying any one space in the shape of a checkerboard on the display panel, and arranged in a pixel column unit. Here, being arranged in the pixel column unit indicates that the plurality of pixels are disposed consecutively in a vertical direction or horizontal direction, so that each pixel column is configured to correspond to a predetermined driving signal line.

The driving signal line refers to a line that transmits a signal for controlling the operation of pixel, a data line refers to a line that transmits image information (data) to be displayed, and the arrangement of pixels is aligned to correspond to such lines to enable more efficient signal transmission and image implementation.

As shown in FIG. 1, the 3D film 200 is disposed on a front surface of the display 110. The display 110 and the 3D film 200 are shown and described as separate components with reference to FIG. 1, but this is only an example, and the display 110 may be implemented as a display module including the 3D film 200.

The memory 120 is a component storing various data necessary for the operation of the display apparatus 100. The memory 120 may be implemented in a form embedded in the display apparatus 100 or may be implemented in a form used by being coupled to the display apparatus 100.

The memory 120 embedded in the display apparatus 100 may be implemented as at least one of non-volatile memory (e.g., dynamic RAM (DRAM), static RAM (SRAM), or synchronous dynamic RAM (SDRAM), non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive, or solid state drive (SSD), and the memory 120 detachable to the display apparatus 100 may be implemented in the form of memory card (e.g., compact flash (CF), secure digital (SD), micro secure digital (micro-SD), mini-secure digital (mini-SD), extreme digital (xD), multi-media card (MMC), external memory (e.g., USB memory) connectable to a USB port, etc.

The memory 120 may store not only data necessary for the operation of the display apparatus 100 but also various programs such as an operating system (or system) software application, firmware software application, driver software application, plug-in (e.g., add-in, add-on, and/or applet) software application, and/or one or more software applications, such as any other suitable software applications, instructions executable by the processor 130, etc. For example, the memory 120 may store instructions that are callable by an application programming interface (API). For example, the memory 120 may store instructions in a library.

In the present disclosure, the term memory 120 may include storage, and read only memory (ROM), random access memory (RAM), or memory card (e.g., micro SD card, and memory stick) mounted on the display apparatus 100 in the at least one processor 130.

At least one instruction stored in the memory 120 may cause the display apparatus 100 to perform operations when individually or collectively executed by the processor 130.

The at least one processor 130 may perform the overall control operation of the display apparatus 100.

The at least one processor 130 may be implemented as a digital signal processor (DSP) that processes digital signals, a microprocessor, and a timing controller (TCON). However, the at least one processor 130 is not limited thereto, and may include, or be defined as, one or more among a central processing unit (CPU), a micro controller unit (MCU), a micro processing unit (MPU), a controller, an application processor (AP), a graphics-processing unit (GPU), a communication processor (CP), and an ARM processor.

In addition, the at least one processor 130 may be implemented as a system on chip (SoC) with embedded processing algorithm, and large scale integration (LSI), and may be implemented in the form of a field programmable gate array (FPGA).

In addition, the at least one processor 130 may perform various functions by executing computer executable instructions stored in the memory 120. FIG. 2 illustrates that only one processor is included in the display apparatus 100, but the display apparatus 100 may include a plurality of processors (e.g., CPU+GPU, and CPU+DSP) when implemented.

When the instructions stored in the memory 120 described above are individually or collectively executed by the processor 130, the display apparatus 100 may perform various operations.

According to at least one embodiment of the present disclosure, the display apparatus 100 may perform dithering in units of a plurality of pixels disposed consecutively in each pixel column to adjust grayscale for each view. Such a grayscale adjustment operation may be performed by the processor 130 based on the instructions, data, programs, etc., that are stored in the memory 120, but is not necessarily limited thereto, and may be performed by a component other than the processor 130, or may be performed in collaboration with the processor 130 and other components.

The units of the plurality of pixels disposed consecutively in each pixel column refer to a predetermined number of pixel group units disposed consecutively within all pixels arranged in each pixel column. One pixel group unit may be one dithering unit for performing dithering. Dithering is described in detail with reference to FIG. 3.

Being disposed consecutively does not indicate that a plurality of pixel borders are disposed in contact with each other. Even though the plurality of pixel borders are not in contact with each other, when each pixel a pixel column is disposed to match a direction of the pixel column, the plurality of pixels may be disposed consecutively.

The number of pixels in the pixel group may be set the same as the number of pixel columns included in one refractive region. For example, when three pixel lines are disposed within one refractive region, three consecutive pixels within each pixel column may be set in a dithering unit.

Here, adjusting the grayscale for each view may indicate that a user recognizes different content according to a location of the user located in front of the display 110. The grayscale is described in detail with reference to FIG. 3.

In the present disclosure, various grayscales may be expressed without cross-talk between images through dithering while implementing a stereoscopic image effect or a multi-image effect by providing different images according to a plurality of views. The crosstalk is described in detail with reference to FIG. 3.

A function of adjusting the grayscale for each view may be applied to not only improve the realism of 3D images, but also differentially expose specific information (e.g., text, markup images, etc.) for each view or provide security effects according to an angle of view.

FIG. 2 illustrates that the display apparatus 100 includes only basic components, but the display apparatus 100 may further include various components in addition to the above-described components.

FIG. 3 is a diagram illustrating an example of the 3D film 200 attached to the display apparatus 100 according to one or more embodiments.

For convenience of description, FIG. 3 illustrates that six pixel columns P1 to P6 in the entire display are covered by two refractive regions L1 and L2.

In the present disclosure, a pixel may refer to a pixel of a minimum unit constituting the screen of the display 110, and each pixel may be a basic element independently emitting or transmitting light to form videos or images.

As shown in FIG. 3, each of pixel columns and refractive regions is in a shape extending in a vertical direction, and may include n pixel columns within one refractive region (where n is 3 in FIG. 3). However, such a structure is only an example, and the size of the display 110, the number of pixel columns, the number of refractive regions, the number of n, etc. may be implemented in various ways.

Referring to FIG. 3, the display 110 includes the plurality of pixel columns P1, P2, P3, P4, P5, and P6 extending in a vertical direction. Each of the plurality of pixel columns P1 to P6 includes a plurality of pixels arranged in the vertical direction. For example, the first pixel column P1 includes a plurality of pixels in the vertical direction.

The three pixel columns are disposed in a lower side of one refractive region L1 or L2, and each pixel column is in a shape extending in the vertical direction, and thus, different pixel columns may be identified with respect to users at different locations in front of the display apparatus 100. For example, in the case of a user n located on the right among users 1 to n of FIG. 1, the leftmost pixel columns P1 and P4 in each of the refractive regions L1 and L2 may be identified, and in the case of the other users, the middle pixel columns P2 and P5 or the rightmost pixel columns P3 and P6 may be identified.

Accordingly, different content are displayed in each of the pixel columns P1 to P3 or P4 to P6 within the same refractive region L1 or L2.

Specifically, FIG. 3 illustrates that an A image is output from the leftmost pixel columns P1 and P4, a B image is output from the middle pixel columns P2 and P5, and a C image is output from the rightmost pixel columns P3 and P6. In this state, the processor 130 adjusts grayscale for each view by performing dithering in units of a plurality of pixels disposed consecutively in each pixel column, based on instructions and data that are stored in the memory 120.

On the other hand, in the case of a display operating by an electrophoretic method, it may be difficult to express grayscale due to its characteristics.

The grayscale is information for expressing one color or contrast at various levels on a display apparatus, and is an important factor that determines the expressive power and image quality of the display apparatus 100.

A display apparatus may control a brightness or color value of each pixel with a digital signal, where the number of grayscales is defined as the number of expressible brightness or color levels. For example, an 8-bit driving method may express levels of grayscale per color channel (R, G, B), enabling to implement a total of 16,777,216 colors (256×256×256).

However, the display 110 implemented by an electrophoretic method is based on a driving principle of implementing an image by applying an electric field and moving charged particles, which has limitations in more precisely controlling positions of the particles. This makes it difficult to adjust the brightness or color in fine levels, which limits the grayscale expression.

To overcome such limitations, in at least one embodiment of the present disclosure, the number of grayscale and expression colors may be increased by performing dithering in units of a plurality of pixels.

Dithering refers to a technology that arranges different brightness or color values in units of pixels so that people recognize brightness or color values as intermediate levels of brightness or color in order to supplement the limited grayscale or color expression on a display apparatus. However, when the conventional technology of dithering N×N pixels is applied as it is, there is a problem that cross-talk occurs due to the mixing of view information.

Cross-talk refers to a phenomenon in which light ray information for different views is unintentionally mixed and incorrect image information is transmitted to a specific user.

For example, when different image information is provided to the plurality of users 1, 2, . . . , n through an LFD, an image viewed to the first user 1 and an image viewed to the second user 2 may be spatially adjacent or overlapped, which may cause the cross-talk phenomenon between light ray information emitted from the display. In particular, when locations of users are close or views change due to movements, boundaries of light ray information are not clearly distinguished and interfere with each other, which may cause a problem of making it difficult to view accurate content.

Accordingly, in various embodiments of the present disclosure, a dithering method that prevents color mixing between views is implemented.

Specifically, while the plurality of pixel columns P1 to P6 included in the display 110 are covered by a refractive region of the 3D film 200, the cross-talk problem may be solved by performing dithering in units of the plurality of pixels disposed consecutively in each pixel column.

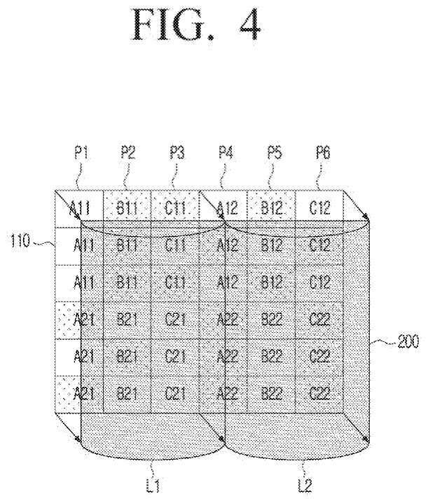

FIG. 4 is a diagram for explaining a method for the display apparatus 110 of FIG. 3 to perform dithering.

The display 110, the 3D film 200, the plurality of pixel columns P1 to P6, and the refractive regions L1 and L2 have been described above, and thus, descriptions thereof are excluded.

In a structure shown in FIG. 4, three consecutive pixels may be grouped in a dithering unit in a vertical direction in each pixel column. Information about the dithering unit for each pixel column may be previously stored in the memory 120. The number of dithering units may be determined to be the same as the number of pixel columns included in one refractive region. That is, when three pixel columns are included as shown in FIG. 3, the dithering unit becomes three pixel units.

Referring to FIG. 4, the pixel column P1 is divided into three A11 and three A21, which are a plurality of pixels aligned in the vertical direction, and A11 and A21 each become one dithering unit. Likewise, the pixel column P2 may be divided into three B11 and three B21, which are a plurality of pixels aligned in the vertical direction, and the remaining pixel columns P3 to P6 may also be divided into a plurality of dithering units.

Referring to FIG. 4, each pixel of the display 110 may be expressed in black or white.

The plurality of pixels driven by an electrophoretic method may be configured in a structure that controls the movement of charged particles for the expression of black or white.

When one dithering unit includes three pixels, as shown in FIGS. 3 and 4, four grayscales may be expressed in each dithering unit.

Specifically, the four grayscales may be expressed as White, Gray1, Gray2, and Black. White denotes when all three pixels express white. Gray1 denotes when any two of the three pixels express white and when any one pixel expresses black. Gray2 denotes when any one of the three pixels expresses white and any two pixels expresses black. Black denotes when all three pixels express black.

That is, when one dithering unit includes n pixels, n+1 grayscales may be expressed.

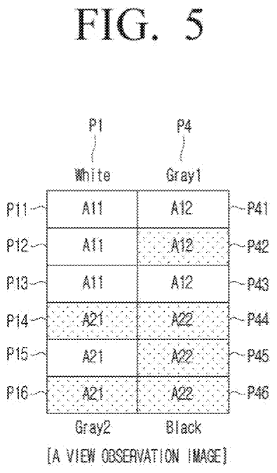

FIGS. 5 to 7 are diagrams for explaining examples of images viewed from different views with respect to the display apparatus performing an operation of FIG. 4. Specifically, FIGS. 5 to 7 illustrate the images viewed from three different positions in front of the display apparatus 100. When different images are output according to three pixel columns disposed in one refractive region, different images are identified at three positions. When an A image is output from the leftmost pixel column, the A image is identified at a position corresponding to the leftmost pixel column. For convenience of explanation, the images are referred to as an A view observation image, a B view observation image, and a C view observation image.

FIG. 5 illustrates the A view observation image. In the case of the display apparatus 100 of a structure as shown in FIG. 3, the A view observation image includes a total of four dithering units. Pixels belonging to pixel columns at positions corresponding to each other within a plurality of refractive regions are included in each dithering unit.

Referring to FIG. 5, {P11, P12, P13} and {P14, P15, P16} in the first pixel column P1 and {P41, P42, P43} and {P44, P45, P46} in the fourth pixel column P4 are identified to a user at a first location.

The processor 130 dithers one of the four grayscales as described above using three pixels included in each dithering unit.

As shown in FIG. 5, when {P11, P12, P13} all express white, a first dithering unit may express white.

In {P41, P42, P43} which is a second dithering unit, P41 and P43 express white and P42 expresses black. Therefore, Gray1, which is one of the four grayscales, may be expressed in the second dithering unit.

In {P14, P15, P16}, which is a third dithering unit, P14 and P16 express black and P15 expresses white. Therefore, the third dithering unit may express Gray2, which is one of the four grayscales.

In {P44, P45, P46} which is a fourth dithering unit, all pixels express black. Therefore, the fourth dithering unit may express Black, which is one of the four grayscales.

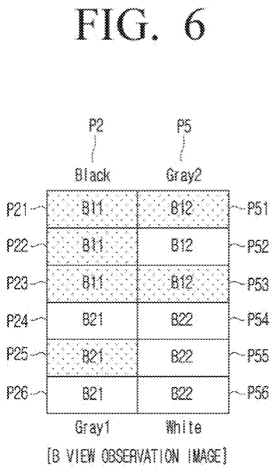

FIG. 6 illustrates the B view observation image identified by a user at a second position. The view observation image includes the second pixel column P2, the fifth pixel column P5, etc. That is, pixels of pixel columns positioned in the middle among lower pixel columns of each refractive region may constitute the view observation image.

Specifically, {P21, P22, P23}, {P24, P25, P26}, {P51, P52, P53}, and {P54, P55, and P56} may each be one dithering unit.

In FIG. 6, {P21, P22, P23} may express Black, and, in {P24, P25, P26}, P24 and P26 may express White, and P25 expresses black so that Gray1 may be expressed.

In addition, in {P51, P52, P53}, P51 and P53 express black, and P52 expresses white, so that Gray2 may be expressed, and {P54, P55, P56} expresses white.

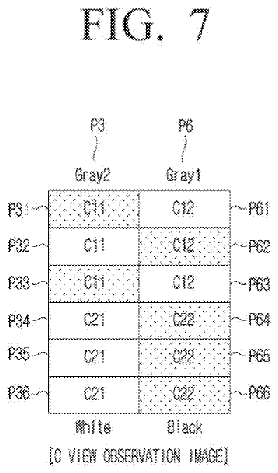

Referring to FIG. 7, the C view observation image includes the last pixel columns P3, P6, etc. within each refractive region. Specifically, {P31, P32, P33}, {P34, P35, P36}, {P61, P62, P63}, and {P64, P65, P66} each become one dithering unit. The processor 130 may provide another content to a user at a third location by using these pixels.

Referring to FIG. 7, {P64, P65, P66}, which is one dithering unit, may express Black, and, in {P61, P62, P63}, which is another dithering unit, P61 and P63 express white, and P62 express black, so that Gray1 may be expressed.

In {P31, P32, P33}, which is another dithering unit, P31 and P33 express black and P32 expresses white so that Gray2 may be expressed, and {P34, P35, P36}, which is another dithering unit, may express White.

As described above, according to embodiments of the present disclosure, a plurality of pixels belonging to different pixel columns may be grouped in dithering units and dithered together, thereby expressing various grayscales without crosstalk between images.

On the other hand, it has been described above that refractive regions of a 3D film are arranged and aligned with each other to more accurately cover a plurality of pixel columns, but when applied to an actual product, an inclination of each refractive region of the 3D film and an inclination of each pixel column of the display 110 may not accurately correspond to each other and may be different from each other. In this case, each refractive region may extend in a direction inclined by a preset angle with respect to a pixel alignment direction of the pixel columns.

FIG. 8 is a diagram for explaining another example of the 3D film 200 attached to the display apparatus 100 according to one or more embodiments.

The display 110 and the 3D film 200 have been described, and thus, redundant descriptions thereof are omitted.

FIG. 8 illustrates that eleven pixels P11, P14, P22, P25, P33, P36, P44, P47, P55, P58, and P66 are covered by one refractive region on the entire display 110.

P11 denotes a pixel located in a first row and a first column among a plurality of pixels of the display 110. P58 denotes a pixel located in a fifth row and an eighth column among the plurality of pixels of the display 110. P22 to P66 also denote pixels located in each column of each row.

Referring to FIG. 8, the display 110 includes a plurality of pixel columns, and each of the pixel columns includes a plurality of pixels arranged in a vertical direction.

In this state, the 3D film 200 is disposed in a direction in which each refractive region is inclined with respect to a direction of the pixel columns. A width of each refractive region may be a width sufficient to cover the plurality of pixel columns. FIG. 8 illustrates that the width of one refractive region covers three pixel columns.

Each refractive region may be divided into a plurality of regions having different refractive indices. In other words, when the refractive region is formed in the form shown in FIG. 8, because a region adjacent to a left boundary, a middle region, and a region adjacent to a right boundary within the refractive region are formed to have different curvatures different, their refractive indices are also different.

The processor 130 may display different content in units of pixels on lower sides of the plurality of regions within each refractive region.

In the case of FIG. 8, the processor 130 may output the same image (e.g., A image of FIG. 5) by using the plurality of pixels P11, P22, P33, P44, P55, and P66 disposed on a lower side of the left boundary region in one refractive region.

In addition, processor 130 outputs another image (e.g., B image of FIG. 6) by using pixels disposed on a lower side of the middle region in one refractive region, i.e., the next pixels P12, P23, P34, P45, P56, and P67 of the pixels that output the A image.

In addition, the processor 130 may output another image (e.g., C image of FIG. 7) by using pixels disposed on a lower side of the right boundary region in one refractive region, i.e., the next pixels P13, P24, P35, P46, P57, and P68 of the pixels that output the B image.

For convenience of explanation, FIG. 8 illustrates that the 3D film 200 is disposed at an angle inclined by 45 degrees with respect to the pixel columns of the refractive region, and a left boundary line of the refractive region is disposed from the upper left to the lower right of the plurality of pixels P11, P22, P33, P44, P55, and P66, but the inclination and arrangement position thereof are not limited thereto and may be changed in various ways.

In the case of a structure as shown in FIG. 8, the processor 130 performs dithering in units of the plurality of pixels within the pixels respectively corresponding to the plurality of regions within each refractive region. The number of pixels included in the dithering unit may be the same as the number of pixel columns included in each refractive region. In the case of FIG. 8, because three pixel columns are included in one refractive region, the dithering unit becomes three pixels.

Specifically, {P11, P22, P33}, {P44, P55, P66}, {P14, P25, P36}, {P47, P58, P69} may be one dithering unit.

Position information (or other identification information) of the pixels belonging to each dithering unit may be preset according to the relationship with the refractive region shape of the 3D film 200 and the display 110 and previously stored in the memory 120.

FIG. 8 illustrate that three pixel columns are included in one refractive region, and pixels of the immediately next pixel columns disposed consecutively are grouped into one dithering unit, but rows and columns of pixels included in the dithering unit may vary depending on the inclination or width of the refractive region. Accordingly, multiple content expressed in various grayscales at various angles and views may be provided.

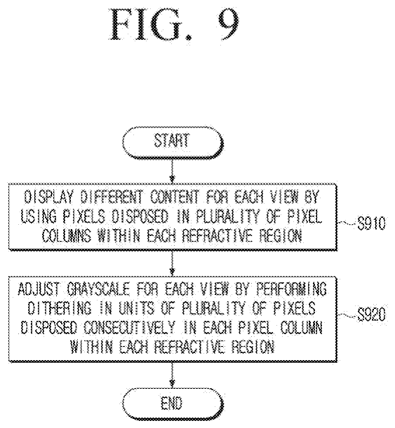

FIG. 9 is a flowchart illustrating a display method of the display apparatus 100 according to one or more embodiments.

Here, the display apparatus 100 may be a display apparatus including the display 110 in which a plurality of pixels each driven by an electrophoretic method are arranged in a pixel column unit, and the 3D film 200 divided into a plurality of refractive regions, and disposed on a front surface of the display 110 so that the plurality of refractive regions cover a plurality of pixel columns of the display 110.

The display method of FIG. 9 may be performed by the display apparatus 100 according to various embodiments described with reference to FIGS. 1 to 8, but is not limited thereto, and may be performed by a display apparatus having a structure in which some components are omitted or added or modified. In addition, the display method of FIG. 9 may be performed by a set-top box connected to the display apparatus 100 in the form as shown in FIGS. 1 to 8, another control device or a signal processing device.

Hereinafter, the display method of FIG. 9 performed by the display apparatus 100 having the configuration of FIG. 2 is described.

The display apparatus 100 may display different content for each view by using pixels disposed in the plurality of pixel columns within each refractive region (S910).

According to one or more embodiments, when n pixels within each refractive region are used as one dithering unit, the display apparatus 100 may display different content for each view.

Subsequently, the display apparatus 100 may perform dithering in units of a plurality of pixels disposed consecutively in each pixel column within each refractive region to adjust grayscale for each view (S920).

According to one or more embodiments, the display apparatus 100 may adjust n+1 grayscales for each view when dithering the n pixels within each refractive region in one dithering unit.

The dithering unit may be determined in various ways according to an arrangement relationship between the 3D film and the display. In this regard, various embodiments have been described with reference to FIGS. 3 and 8, and thus, redundant descriptions thereof are omitted.

As described above, the display apparatus 100 may adjust grayscale by displaying different content by using the plurality of pixels in the display 110 and performing dithering. Accordingly, various grayscales may be expressed without crosstalk occurring.

Although various embodiments of the present disclosure have been specifically described according to each embodiment above, each embodiment is not necessarily implemented alone and may be implemented partially or wholly together with the other embodiments.

The methods according to at least some of various embodiments of the present disclosure described above may be implemented in the form of an application that is installable in the existing display apparatus.

In addition, the methods according to at least some of various embodiments of the present disclosure described above may be implemented only through software upgrade or hardware upgrade of the existing display apparatus.

For example, when a recording medium storing thereon a program for performing these methods is stored is mounted on a display apparatus including a display and a 3D film described with reference to FIGS. 1 to 8 or an electronic apparatus that supplies signals to the display apparatus or controls the signals, the display apparatus or the electronic apparatus may perform dithering using the method described above according to various embodiments.

In addition, the methods according to at least some of various embodiments of the present disclosure described above may be performed through an embedded server provided in the display apparatus or at least one external server of the display apparatus.

According to an embodiment of the present disclosure, various embodiments described above may be implemented as software including instructions stored in a machine-readable storage medium readable by a device (e.g., a computer). The machine is a device capable of calling a stored instruction from a storage medium and operating according to the called instruction, and may include an electronic apparatus (e.g., display apparatus A) according to disclosed embodiments. When the instruction is executed by the processor, the processor may perform a function corresponding to the instruction directly or by using other components under the control of the processor. The instruction may include codes generated or executed by a compiler or an interpreter. The machine-readable storage medium may be provided in the form of a non-transitory storage medium. Here, the term ‘non-transitory storage medium’ indicates that the storage medium is tangible without including a signal (e.g., electromagnetic waves), and does not distinguish whether data are semi-permanently or temporarily stored in the storage medium. For example, the ‘non-transitory storage medium’ may include a buffer in which data is temporarily stored. According to an embodiment, a method according to various embodiments of the disclosure in the specification may be provided by being included in a computer program product. The computer program product, which is a commodity, may be traded between sellers and buyers. The computer program product may be distributed in a form of the machine-readable storage medium (e.g., a compact disc read only memory (CD-ROM)), or may be distributed through an application store or directly or online (e.g., download or upload) between two user devices (e.g., smartphones). In the case of online distribution, at least some of the computer program product (e.g. downloadable app) may be at least temporarily stored or temporarily provided in a machine-readable storage medium such as memory of a server of a manufacturer, a server of an application store or a relay server.

While embodiments have been described with reference to the figures, it will be understood by those of ordinary skill in the art that various changes in form and details may be made therein without departing from the spirit and scope as defined by the following claims and their equivalents.

What is claimed is:

1. A display apparatus comprising:
a display comprising a plurality of pixels included in a pixel column unit, the plurality of pixels being configured to be driven based on electrophoretic method;
a three-dimensional film comprising a plurality of refractive regions and on a plurality of pixel columns of the display;
memory configured to store instructions; and
one or more processors comprising processing circuitry, when executing the instructions, is configured to cause the display apparatus to:
perform dithering in units of a plurality of pixels consecutively included in each pixel column of the plurality of pixel columns to adjust grayscale for each view of a plurality of views.

2. The display apparatus as claimed in claim 1, wherein each pixel column of the plurality of pixel columns comprises the plurality of pixels in a vertical direction, and
wherein each refractive region of the plurality of refractive regions extends in the vertical direction.

3. The display apparatus as claimed in claim 2, wherein the one or more processors, when executing the instructions, is further configured to cause the display apparatus to:
display different content in unit of at least one pixel column of the plurality of pixel columns within each refractive region of the plurality of refractive regions.

4. The display apparatus as claimed in claim 3, wherein the one or more processors, when executing the instructions, is further configured to cause the display apparatus to:
perform the dithering in units of pixels, of which number is same as a number of the plurality of pixel columns, among pixels included in each pixel column of the plurality of pixel columns included in each refractive region of the plurality of refractive regions.

5. The display apparatus as claimed in claim 1, wherein each pixel column of the plurality of pixel columns comprises the plurality of pixels in a vertical direction, and
wherein each refractive region of the plurality of refractive regions extends in a direction inclined at a preset angle with respect to the vertical direction.

6. The display apparatus as claimed in claim 5, wherein each refractive region of the plurality of refractive regions is divided into a plurality of regions having different refractive indices, and
wherein the one or more processors, when executing the instructions, is further configured to cause the display apparatus to:
display different content in units of pixels corresponding to each region of the plurality of regions within each refractive region of the plurality of refractive regions.

7. The display apparatus as claimed in claim 6, wherein the one or more processors, when executing the instructions, is further configured to cause the display apparatus to:
perform the dithering in units of pixels, of which number is same as a number of pixel columns included in each refractive region of the plurality of refractive regions, among pixels corresponding to each region of the plurality of regions.

8. The display apparatus as claimed in claim 1, wherein the three-dimensional film is a lenticular lens, and
wherein the plurality of refractive regions are a plurality of lens regions in the lenticular lens.

9. A display method of a display apparatus comprising a display in which a plurality of pixels, each configured to be driven by an electrophoretic method, are in a pixel column unit, and a three-dimensional film divided into a plurality of refractive regions and on a plurality of pixel columns of the display, the display method comprising:
displaying different content for each view of a plurality of vies by using pixels in the plurality of pixel columns within each refractive region of the plurality of refractive regions; and
adjusting grayscale for each view of a plurality of view by performing dithering in units of a plurality of pixels consecutively in each pixel column of the plurality of pixel columns within each refractive region of the plurality of refractive regions.

10. The display method as claimed in claim 9, wherein each pixel column of the plurality of pixel columns comprises the plurality of pixels in a vertical direction, and
wherein each refractive region of the plurality of refractive regions extends in the vertical direction.

11. The display method as claimed in claim 10, wherein the displaying of the different content for each view of the plurality of view comprises:
displaying different content in unit of at least one pixel column among the plurality of pixel columns within each refractive region of the plurality of refractive regions.

12. The display method as claimed in claim 11, wherein the adjusting of the grayscale for each view comprises:
performing the dithering in units of pixels, of which number is same as a number of the plurality of pixel columns, among pixels included in each pixel column of the plurality of pixel columns included in each refractive region of the plurality of refractive regions.

13. The display method as claimed in claim 9, wherein each pixel column of the plurality of pixel columns comprises the plurality of pixels in a vertical direction, and
wherein each refractive region of the plurality of refractive regions extends in a direction inclined by a preset angle with respect to the vertical direction.

14. The display method as claimed in claim 13, wherein each refractive region of the plurality of refractive regions is divided into a plurality of regions having different refractive indices, and
wherein the displaying of the different content for each view of a plurality of views comprises:
displaying different content in units of pixels corresponding to each region of the plurality of regions within each refractive region of the plurality of refractive regions.

15. The display method as claimed in claim 14, wherein the adjusting of the grayscale for each view the plurality of views comprises:
performing the dithering in units of pixels, of which number is same as a number of pixel columns included in each refractive region of the plurality of refractive regions, among pixels corresponding to each region of the plurality of regions.
